(19) United States
(12) Patent Application Publication
(10) Pub. No.: US 2004/0055575 A1
(43) Pub. Date: Mar. 25, 2004

(54) System and method for common rail pressure control

(76) Inventors: James E. McCarthy JR., Canton, MI (US); Dennis McDonald, Canton, MI (US); James A. West, Simpsonville, SC (US); Andrew May, Wauwatosa, WI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/214,521

(22) Filed: Aug. 8, 2002

(51) Int. Cl. F02M 1/00

(52) U.S. Cl. 123/457; 123/497

(57) ABSTRACT

A system and method for controlling pressure within a common rail fluid distribution system use variable gains for a PID and feed forward controller that controls a pump that pressurizes the common rail. The pressure controller implements a combined feedback/feed forward control strategy with variable gains based on engine speed and a fluid quantity. In one embodiment, the feedback control loop includes proportional, integral, and derivative terms with variable gains determined based on pumped fuel quantity and engine speed. Alternatively, the proportional, integral, and derivative gains are determined based on injected fuel quantity per engine cycle and engine speed, or based on pump output, i.e. the product of pumped fluid quantity and engine speed. A variable gain feed forward control has its gain based on pumped fuel per cycle and engine speed, or alternatively based on pump output per unit time.

### BACKGROUND OF THE INVENTION

1. Field of the Invention

The present invention relates to a system and method for controlling fluid pressure within a common rail fluid distribution device of a multi-cylinder internal combustion engine.

2. Background Art

Common rail fluid distribution systems are used in various types of internal combustion engines, such as diesel engines, for example. An accumulator or rail is used to distribute a fluid to multiple sites around the engine, each typically associated with an engine cylinder. The fluid may be used to control the operation of engine components, such as the hydraulic oil used to control actuation of injectors in a HEUI (hydraulically actuated electronic unit injector) system. A common rail may also be used to deliver fuel to injectors or nozzles associated with each cylinder of the engine.

Whether used to distribute hydraulic fluid, fuel, or another liquid, the timing and quantity of the liquid delivered to its destinations is dependent upon the pressure within the common rail. As such, a number of strategies have been developed to control or govern the rail pressure. Conventional control theory may be applied to control the rail pressure using feedback control including proportional (P), integral (I), and/or derivative (D) control often in combination with feed forward (FF) control. The behavior of the control system is determined largely based on the gains applied to the various terms (P,I,D, and/or FF) used by the pressure controller or governor. The gains may be fixed scalar values that are determined during calibration of the engine control system, such as disclosed in U.S. Pat. No. 6,016,791 to Thomas et al. Alternatively, variable gains have been used to adjust the control system behavior based on one or more current operating conditions or parameters. For example, one prior art strategy varies control parameters or gains based on rail pressure error (the difference between desired and measured rail pressure) and engine speed. While this approach may provide more desirable control characteristics for some applications, it requires additional resources for calibration and testing, and may not provide optimal accuracy for control, particularly under transient operating conditions.

The present inventors have recognized the shortcomings of the prior art approaches and have developed a system and method for controlling pressure for common rail systems that is believed to provide more accurate and continuous control.

### DISCLOSURE OF THE INVENTION

The present invention provides a system and method for controlling pressure within a common rail fluid distribution system of an internal combustion engine having a pump for supplying pressurized fluid to a common rail. A pressure controller monitors pressure within the common rail and controls the pump to reduce the error between a desired rail pressure and an actual rail pressure as measured by a pressure sensor. The pressure controller implements a combined feedback/feed forward control strategy with variable gains. In one embodiment, the feedback control loop includes proportional, integral, and derivative terms with variable gains determined based on pumped fluid quantity and engine speed, with the pumped fluid quantity preferably corresponding to pumped fuel. In an alternative embodiment, the proportional, integral, and derivative gains are determined based on injected fuel quantity and engine speed. Another embodiment determines the proportional, integral, and derivative gains based on pumped output, i.e. the product of pumped fluid quantity and engine speed. The present invention also preferably includes a variable gain feed forward control with gains based on pumped fuel quantity and engine speed, or alternatively based on pumped output.

The present invention also includes computer readable storage media having stored instructions executable by a computer to control rail pressure of a common rail fluid distribution system in an internal combustion engine.

The present invention provides a number of advantages. For example, determining PID and feed forward controller gains according to the present invention provides more accurate control of the rail pressure over the entire engine operating range as compared to prior art approaches. This may lead to improved performance, emissions, and driveability of vehicles employing this strategy. Use of injected fuel quantity and engine speed based gains may be able to reduce the effort required for engine calibration. PID and feed forward control based on pumped output provides more continuous gain tables that result in improved rail pressure stability and ease of calibration. In addition, gains based on pumped output reduce the memory required for the controller by requiring less calibration tables.

Various other advantages and features of the present invention are readily apparent from the following detailed description of the best mode for carrying out the invention when taken in connection with the accompanying drawings.

### BRIEF DESCRIPTION OF THE DRAWINGS

FIG. 1 is a schematic/block diagram illustrating operation of a system or method for controlling pressure within a common rail fluid distribution system of an internal combustion engine according to one embodiment of the present invention;

FIG. 2 is a block diagram illustrating a common rail fuel system with a pressure control strategy according to one embodiment of the present invention;

FIG. 3 is a block diagram illustrating alternative embodiments for a rail pressure governor having gains based on injected fuel per cycle or pumped fuel per cycle according to the present invention;

FIG. 4 is a block diagram illustrating another alternative embodiment for a rail pressure governor having gains based on pump output according to the present invention; and

FIG. 5 is a flow chart illustrating operation of a system or method for controlling pressure in a common rail fluid distribution system according to the present invention.

### DETAILED DESCRIPTION OF THE PREFERRED EMBODIMENT(S)

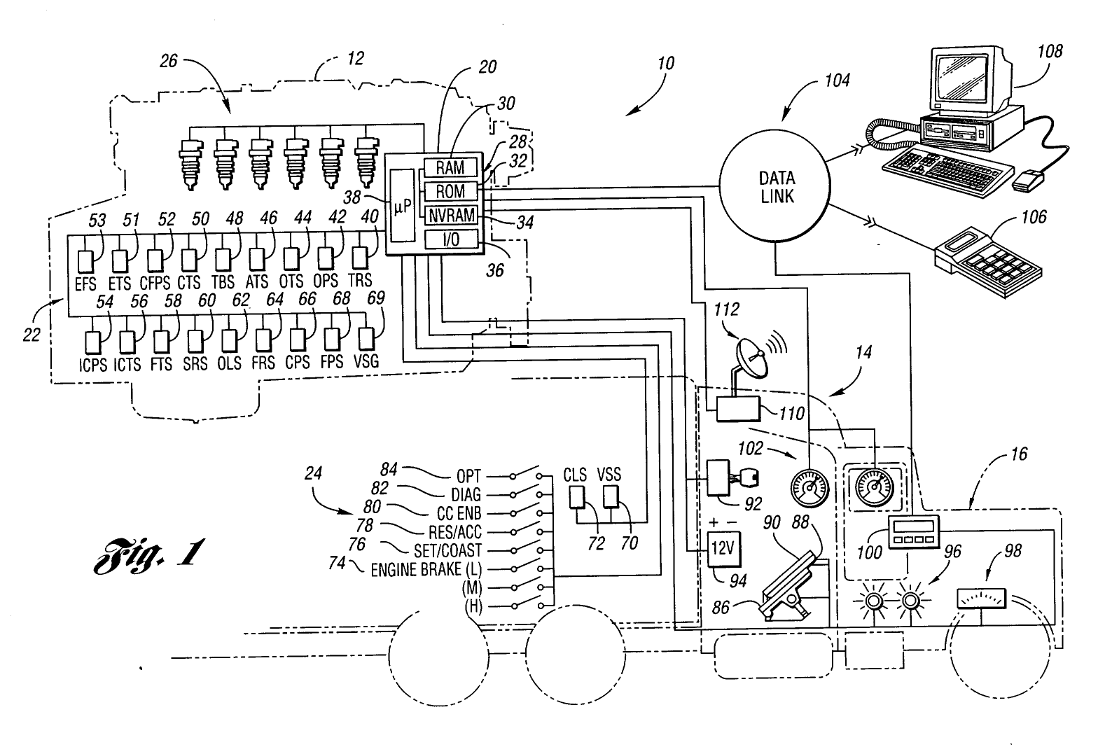

FIG. 1 provides a schematic/block diagram illustrating operation of a system or method for controlling pressure within a common rail fluid distribution system of an internal combustion engine according to one embodiment of the present invention. System 10 includes a multi-cylinder compression ignition internal combustion engine, such as a diesel engine 12, which may be installed in a vehicle 14 depending upon the particular application. In one embodiment, vehicle 14 includes a tractor/semi-trailer 16. Diesel engine 12 is installed in tractor/semi-trailer 16 and interfaces with various sensors and actuators located on engine 12 and tractor/semi-trailer 16 via engine and vehicle wiring harnesses. In other applications, engine 12 may be used to operate industrial and construction equipment, or in stationary applications for driving generators, compressors, and/or pumps and the like.

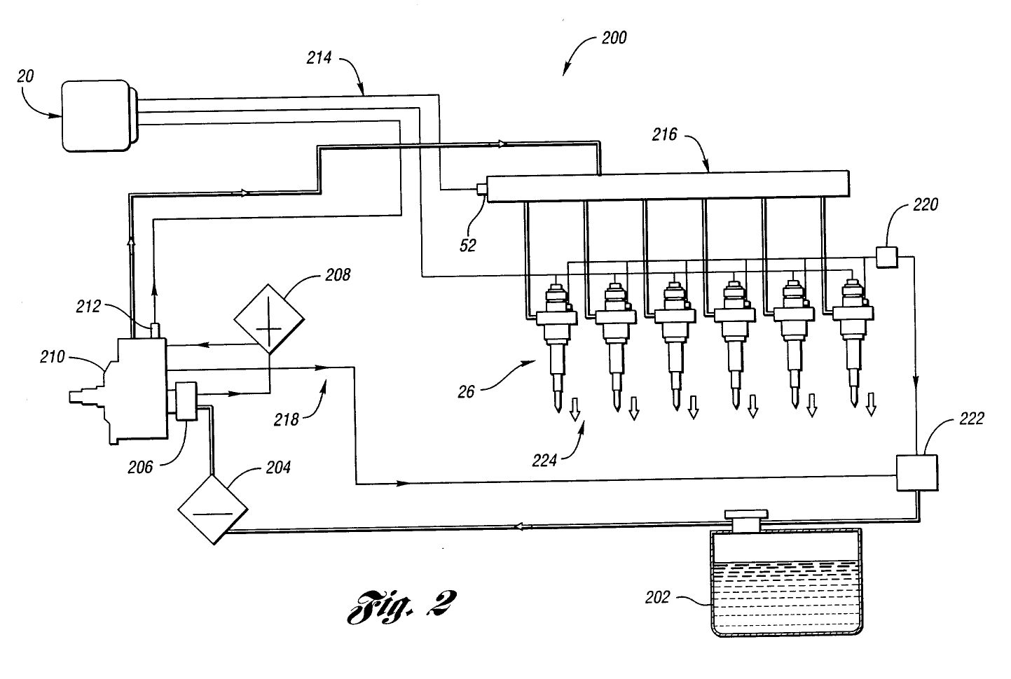

An electronic engine control module (ECM) 20 receives signals generated by engine sensors 22 and vehicle sensors 24 and processes the signals to control engine and/or vehicle actuators such as high pressure pump (FIG. 2) and/or fuel injectors 26, for example. ECM 20 preferably includes computer-readable storage media, indicated generally by reference numeral 28 for storing data representing instructions executable by a computer to control engine 12. Computer-readable storage media 28 may also include calibration information in addition to working variables, parameters, and the like. In one embodiment, computer-readable storage media 28 include a random access memory (RAM) 30 in addition to various non-volatile memory such as read-only memory (ROM) 32, and non-volatile memory (NVRAM) 34. Computer-readable storage media 28 communicate with a microprocessor 38 and input/output (I/O) circuitry 36 via a standard control/address bus. As will be appreciated by one of ordinary skill in the art, computer-readable storage media 28 may include various types of physical devices for temporary and/or persistent storage of data which includes solid state, magnetic, optical, and/or combination devices. For example, computer readable storage media 28 may be implemented using one or more physical devices such as DRAM, PROMS, EPROMS, EEPROMS, flash memory, and the like. Depending upon the particular application, computer-readable storage media 28 may also include floppy disks, CD ROM, DVD, and the like.

In a typical application, ECM 20 processes inputs from engine sensors 22, and vehicle sensors/switches 24 by executing instructions stored in computer-readable storage media 28 to generate appropriate output signals for control of engine 12 via corresponding actuators. In one embodiment of the present invention, engine sensors 22 include a timing reference sensor (TRS) 40 which provides an indication of the crankshaft position and may be used to determine engine speed, preferably in revolutions per minute (rpm). An oil pressure sensor (OPS) 42 and oil temperature sensor (OTS) 44 are used to monitor the pressure and temperature of the engine oil, respectively. Oil temperature may be used to determine a desired rail pressure set point as described in greater detail below.

An air temperature sensor (ATS) 46 is used to provide an indication of the current intake or ambient air temperature. A turbo boost sensor (TBS) 48 is used to provide an indication of the boost pressure of a turbocharger which is preferably a variable geometry or variable nozzle turbocharger. As known by those of ordinary skill in the art, TBS 48 may also be used to provide an indication of the intake manifold pressure. Coolant temperature sensor (CTS) 50 is used to provide an indication of the coolant temperature. Depending upon the particular engine configuration and application, various additional sensors may be included. For example, engines which utilize exhaust gas recirculation (EGR) preferably include an EGR temperature sensor (ETS) 51 and an EGR flow sensor (EFS) 53.

Common rail fluid distribution systems may include one or more pressure sensors to detect the pressure within the common rail and provide a corresponding signal to the pressure controller within the ECM 20. As previously described, common rail systems may be used to distribute hydraulic oil or fluid, such as used in some HEUI systems, or to distribute fuel. A common rail fuel system preferably includes a corresponding fuel pressure sensor (CFPS) 52. Similarly, an intercooler coolant pressure sensor (ICPS) 54 and temperature sensor (ICTS) 56 may be provided to sense the pressure and temperature of the intercooler coolant. Engine 12 also preferably includes a fuel temperature sensor (FTS) 58 and a synchronous reference sensor (SRS) 60. SRS 60 provides an indication of a specific cylinder in the firing order for engine 12. This sensor may be used to coordinate or synchronize control of a multiple-engine configuration such as used in some stationary generator applications.

Engine 12 may also include an oil level sensor (OLS) 62 to provide various engine protection features related to a low oil level. A fuel restriction sensor (FRS) 64 may be used to monitor a fuel filter and provide a warning for preventative maintenance purposes. A fuel pressure sensor (FPS) 68 provides an indication of fuel pressure to warn of impending power loss and engine fueling. Similarly, a crankcase pressure sensor (CPS) 66 provides an indication of crankcase pressure which may be used for various engine protection features by detecting a sudden increase in crankcase pressure indicative of an engine malfunction.

System 10 preferably includes various vehicle sensors/switches 24 to monitor vehicle operating parameters and driver input used in controlling vehicle 14 and engine 12. For example, vehicle sensors/switches 24 may include a vehicle speed sensor (VSS) which provides an indication of the current vehicle speed. A coolant level sensor (CLS) 72 monitors the level of engine coolant in a vehicle radiator. Switches used to select an engine operating mode or otherwise control operation of engine 12 or vehicle 14 may include an engine braking selection switch 74 which preferably provides for low, medium, high, and off selections, cruise control switches 76, 78, and 80, a diagnostic switch 82, and various optional, digital, and/or analog switches 84, such as a high idle switch, for example. ECM 20 also receives signals associated with an accelerator or foot pedal 86, a clutch 88, and a brake 90. ECM 20 may also monitor position of a key switch or ignition switch 92 and a system voltage provided by a vehicle battery 94 to determine current operating conditions and control engine 12 and/or vehicle 14.

ECM 20 may communicate with various vehicle output devices such as status indicators/lights 96, analog displays 98, digital displays 100, and various analog/digital gauges 102. In one embodiment of the present invention, ECM 20 utilizes an industry standard data link 104 to broadcast various status and/or control messages which may include engine speed, accelerator pedal position, vehicle speed, and the like. Preferably, data link 104 conforms to SAE J1939 and SAE J1587 to provide various service, diagnostic, and control information to other engine systems, subsystems, and connected devices such as display 100. Preferably, ECM 20 includes control logic to determine current engine and ambient operating conditions to select corresponding gains for a PID and/or feed forward pressure controller to control the pressure within one or more common rail fluid distribution systems. As described in greater detail below, ECM 20 preferably determines at least a current operating mode, oil temperature and engine speed to determine a desired rail pressure. In addition, ECM 20 uses engine speed and injected fuel per cycle or pumped fuel per cycle, or uses pump output to determine appropriate PID and feed forward gains.

A service tool 106 may be periodically connected via data link 104 to program selected parameters stored in ECM 20 and/or receive diagnostic information from ECM 20. Likewise, a computer 108 may be connected with the appropriate software and hardware via data link 104 to transfer information to ECM 20 and receive various information relative to operation of engine 12, and/or vehicle 14. Similarly, transceiver 110 and antenna 112 may be used to wirelessly send and/or receive program, diagnostic, or other information.

FIG. 2 is a block diagram illustrating the components and fluid flow in a representative common rail fluid distribution system utilizing a pressure control strategy according to one embodiment of the present invention. Common rail fluid distribution system 200, in this embodiment, is used to deliver fuel from a fuel tank 202. Low-pressure gear pump 206 draws fuel from fuel tank 202 via a primary fuel filter 204 and pumps the fuel through a secondary filter 208 into a high-pressure pump 210. A fuel metering valve or proportional valve 212 is electronically controlled by ECM 20 via wiring harness 214 to direct fuel into a high-pressure plunger cavity of high-pressure pump 210. The remaining fuel is spilled as represented by 218 to junction block 222 where it is combined with injector spill fuel and returned to fuel tank 202. Metering valve 212 is preferably an integral component of high-pressure pump 210 to reduce losses. However, implementations using a discrete metering valve or multiple metering valves may be appropriate for certain applications and are within the scope of the present invention. As used throughout this description, control of high-pressure pump 210 is used interchangeably with control of metering valve 212. In actual operation, high-pressure pump 210 may be turned on or off separately from control or modulation of metering valve 212.

In one preferred embodiment, a rail pressure governor or controller implemented within the ECM 20 uses variable gains to control the amount of current sent to metering valve 212 as explained in greater detail below. In general, the rail pressure governor controls metering valve 212 based upon a desired rail pressure and measured rail pressure (determined by pressure sensor 52 and communicated to ECM 20 via wiring harness 214) with control system parameters or gains determined according to current engine operating conditions. In various embodiments, PID controller gains of the rail pressure governor are determined based on pumped or injected fuel quantity and engine speed, or pump output per unit time. A feed forward controller provides open-loop control with its gain based on pumped fuel quantity and engine speed or alternatively pump output per unit time. It should be noted that pump speed could be used in place of engine speed and that engine load could be used in place of injected or pumped fuel quantity. In addition, injected fuel quantity could be used in place of pumped fuel quantity for the feed forward controller of the rail pressure governor. The rail pressure governor or controller attempts to reduce the pressure error or deviation between the desired and actual rail pressure to maintain the fuel pressure in high-pressure rail 216 by modulating metering valve 212 to control the amount of fuel supplied by high-pressure pump 210.

Common rail 216 is used to deliver fuel to a plurality of engine locations. In this embodiment, the plurality of engine locations correspond to injectors 26, each associated with an engine cylinder (not specifically illustrated). Injectors 26 are actuated by ECM 20 via wiring harness 214 to control the quantity and timing of injected fuel 224 for each cylinder. As known by those of ordinary skill in the art, the quantity and timing of fuel injected into the combustion chamber of each cylinder is also a function of the pressure within common rail 216. As such, continuous and accurate control of the pressure within common rail 216 is beneficial to improve emissions, efficiency, and drivability. A regulator valve 220 regulates the upstream pressure of injector spilled fuel which is then combined with pump spilled fuel at junction block 222 before being returned to fuel tank 202.

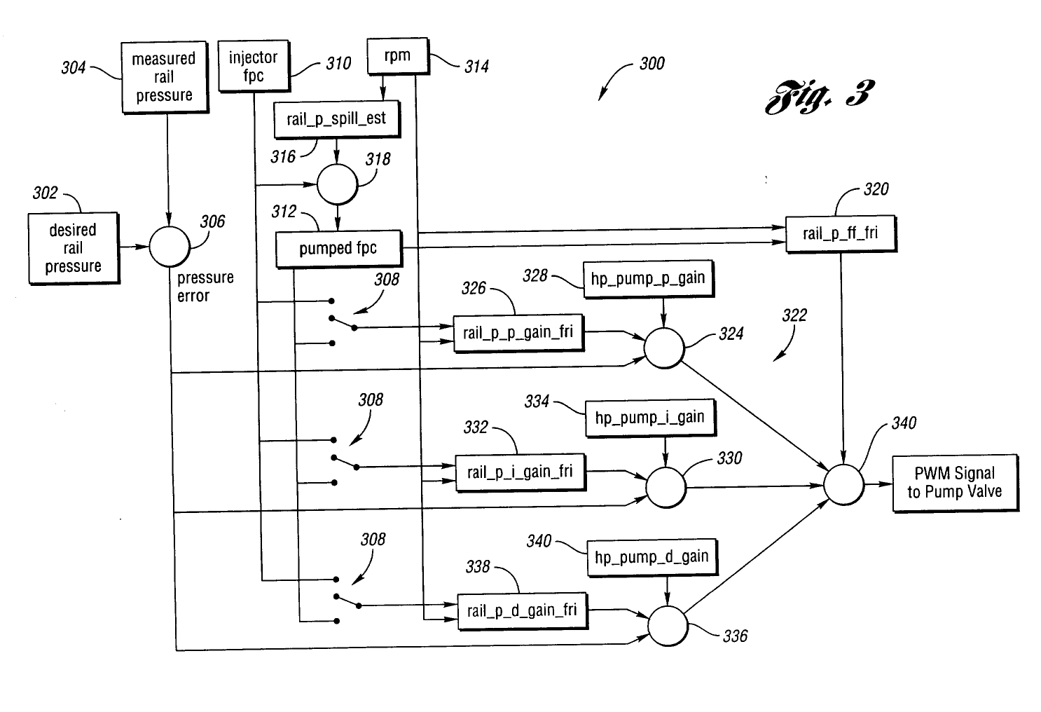

FIG. 3 is a block diagram illustrating alternative embodiments for a rail pressure governor having gains based on injected fuel per cycle or pumped fuel per cycle according to the present invention. Rail pressure governor 300 determines a desired rail pressure based on a current engine operating conditions or modes as represented by block 302. The desired rail pressure or rail pressure setpoint is preferably determined as described in commonly owned and copending U.S. Patent application Ser. No. 10/___,___ (Docket No. 98-1-138/DDC0406PUS) titled “Injection Control For A Common Rail Fuel System”, the disclosure of which is hereby incorporated by reference in its entirety. However, the present invention is independent of the particular method used to determine the desired rail pressure as represented by block 302. A measured or inferred rail pressure is determined as represented by block 304 and is used to determine a rail pressure error or deviation at block 306.

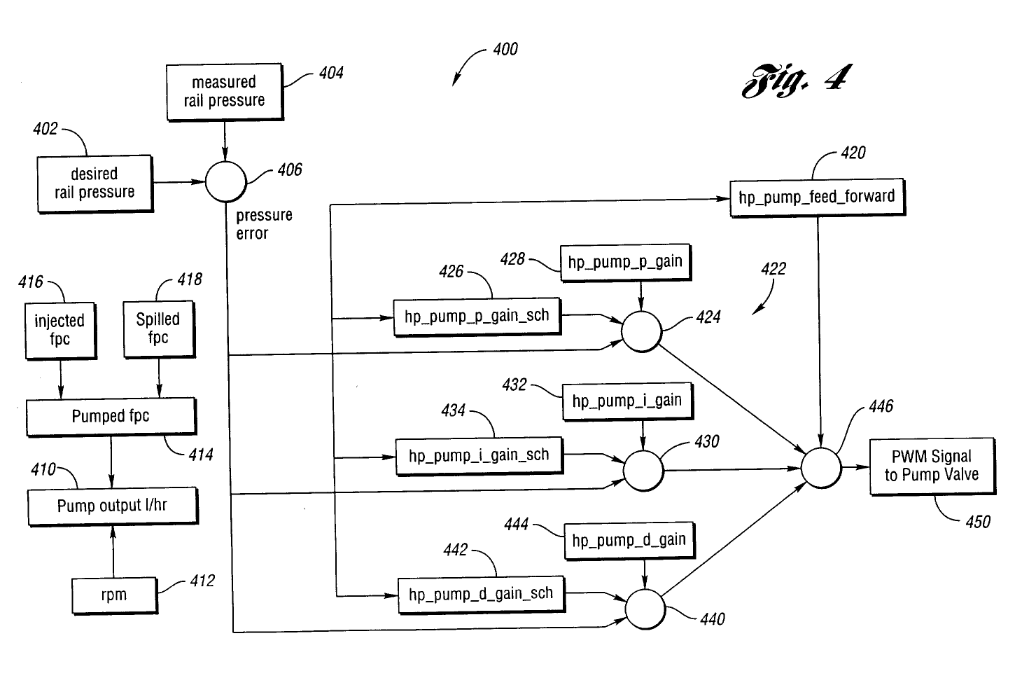

A software calibration switch or flag represented by reference 308 determines whether an injected fuel per cycle 310 or pumped fuel per cycle 312 calculation is used by the PID controller. Pumped fuel per cycle or pumped output (illustrated in FIG. 4) is preferably used by the feed forward controller in determining an open loop setpoint. Engine speed 314 is used to access a corresponding look-up table to determine an estimate of the total spilled fuel at block 316. The spilled fuel quantity may be represented by a control quantity of the injectors and a leaked quantity of the injectors as described in greater detail in commonly owned and copending U.S. Patent application Ser. No. 10/___,___ (Docket No. 01-1-167/DDC0483PUS) titled “Engine Control For A Common Rail Fuel System Using Fuel Spill Determination”, the disclosure of which is hereby incorporated by reference in its entirety. The injected fuel per cycle 310 and estimated spilled fuel 316 is used to determine the pumped fuel per cycle 312 as represented by block 318. In this embodiment, the pumped fuel per cycle 312 is used in combination with the engine speed 314 to determine the feed forward open loop setpoint term 320 which is combined with the PID controller terms 322 as represented by block 340 to determine a pulse width modulated (PWM) control signal for the high-pressure pump or metering valve. Similarly, variable gains represented by block 326, 332, and 338 may be determined based on engine speed 314 and pumped fuel per cycle 312 or injected fuel per cycle 310 depending upon the value of calibration switch 308. Variable proportional gain 326 (preferably accessed from a two-dimensional look-up table) is used in combination with a programmable high-pressure pump proportional gain 328 (preferably a scalar) and pressure error 306 to determine a proportional term for the PID controller at block 324. Likewise, variable integral gain 332 (preferably provided by a two-dimensional look-up table) is used in combination with programmable high-pressure pump integral gain 334 (preferably a scalar) and rail pressure error 306 to determine the integral term of the PID controller as represented by block 330. Variable derivative gain 338 (preferably provided by a two-dimensional look-up table) is used in combination with a programmable high-pressure pump derivative gain 340 (preferably a scalar) and rail pressure error 306 to determine a derivative term of the PID controller at block 336. The gains are preferably stored in memory and accessed based on the current engine operating conditions, i.e. engine speed and pumped fuel per cycle or injected fuel per cycle. Depending upon the particular application, one or more equations may be used to in place of corresponding values stored in memory with the applicable gains periodically calculated using current engine operating conditions.

FIG. 4 is a block diagram illustrating another alternative embodiment for a rail pressure governor having gains based on pump output per unit time according to the present invention. The present inventors have recognized that high-pressure pump utilization and pump output per unit time could be expressed as a function of metering valve current. As such, the two-dimensional tables used to specify the variable gains of the PID and feed forward controllers may be reduced to a single column. This may reduce the calibration and testing effort required and ultimately provide improved accuracy and continuity for the rail pressure governor.

Rail pressure governor 400 determines a desired rail pressure 402 in a similar fashion as described above with reference to FIG. 3. Desired rail pressure 402 is combined with a measured rail pressure 404 to determine a pressure error at block 406. The pump output per unit time is determined as represented by block 410 based on engine speed 412 and pumped fuel per cycle 414, which in turn is based upon injected fuel per cycle 416 and spilled fuel per cycle 418. A feed forward open loop set point 420 may then be a programmable scalar value rather than a single column of values based on the pump output 410. PID controller 422 then calculates a proportional term at block 424 using a variable proportional gain 426 (preferably a single column) based on pump output 410, a high-pressure pump proportional gain 428 (preferably a programmable constant or scalar) and pressure error 406. Similarly, PID controller 422 determines an integral term at block 430 based on high-pressure pump integral gain 432 (preferably a programmable constant or scalar), variable integral gain 434 determined based on pump output 410, and pressure error 406. Likewise, PID controller 422 determines a derivative term at block 440 based on high-pressure pump derivative gain 444 (preferably a programmable constant or scalar), variable derivative gain 442 based on pump output 410, and pressure error 406. The various control terms are combined at block 446 to determine an appropriate control signal for the high-pressure pump or metering valve as represented by block 450.

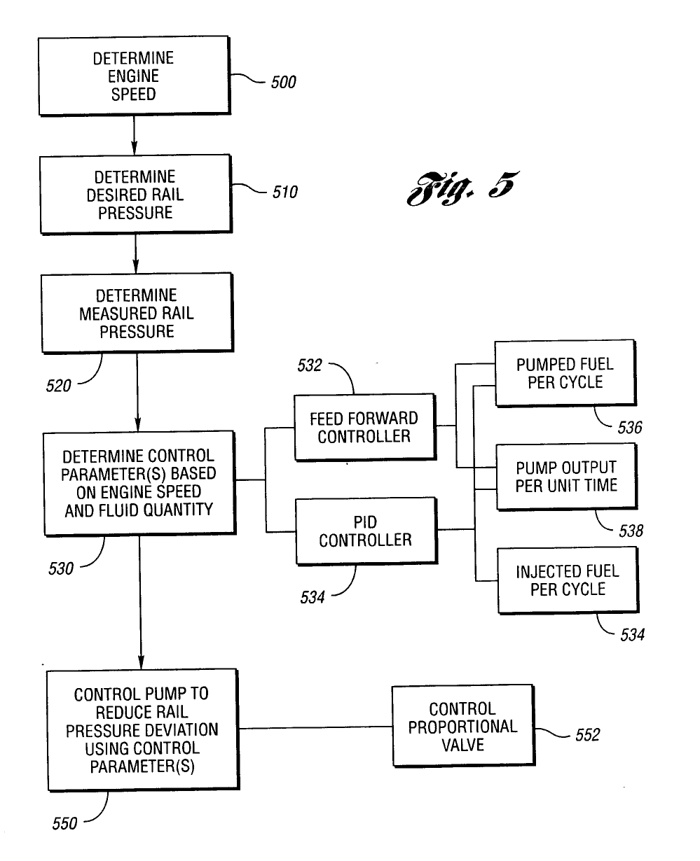

A block diagram illustrating operation of one embodiment for a system or method for controlling rail pressure in a common rail fluid distribution system according to the present invention is shown in FIG. 5. As will be appreciated by one of ordinary skill in the art, the block diagram of FIG. 5 represents control logic which may be implemented or effected in hardware, software, or a combination of hardware and software. The various functions are preferably effected by a programmed microprocessor, such as included in the DDEC controller manufactured by Detroit Diesel Corporation, Detroit, Mich. Of course, control of the engine/vehicle and/or associated components may include one or more functions implemented by dedicated electric, electronic, or integrated circuits or controllers. As will also be appreciated by those of skill in the art, the control logic may be implemented using any of a number of known programming and processing techniques or strategies and is not limited to the order or sequence illustrated in FIG. 5. For example, interrupt or event driven processing is typically employed in real-time control applications, such as control of an engine or vehicle rather than a purely sequential strategy as illustrated. Likewise, parallel processing, multi-tasking, or multi-threaded systems and methods may be used to accomplish the objectives, features, and advantages of the present invention. The invention is independent of the particular programming language, operating system, processor, or circuitry used to develop and/or implement the control logic illustrated. Likewise, depending upon the particular programming language and processing strategy, various functions may be performed in the sequence illustrated, at substantially the same time, or in a different sequence while accomplishing the features and advantages of the present invention. The illustrated functions may be modified, or in some cases omitted, without departing from the spirit or scope of the present invention.

In various embodiments of the present invention, the control logic illustrated is implemented primarily in software and is stored in computer readable storage media within the ECM. As one of ordinary skill in the art will appreciate, various control parameters, instructions, and calibration information stored within the ECM may be selectively modified by the vehicle owner/operator while other information is restricted to authorized service or factory personnel. The computer readable storage media may also be used to store engine/vehicle operating information and diagnostic information. Although not explicitly illustrated, various steps or functions may be repeatedly performed depending on the type of processing employed.

In the representative embodiment of the present invention illustrated in FIG. 5, block 500 represents determination of the current engine speed. As described above, depending upon the particular application, pump speed could be used in place of engine speed without departing from the invention. A desired rail pressure is determined as represented by block 510. A measured rail pressure is determined as represented by block 520. One or more control parameters are then determined based on the engine speed and a fluid quantity as represented by block 530. Feed forward controller parameters 532 may be based upon pumped fuel per cycle 536 (or alternatively engine load) or pump output per unit time 538. Similarly, PID controller parameters 534 may be based upon pumped fuel per cycle 536, pump output per unit time 538, or injected fuel per cycle 540. Any particular application may include one or more of the methods described above with selection based upon a calibration flag or switch, a hardwired switch, an engine mode or operating conditions, or the like.

The control parameters determined as represented by block 530 may be used in combination with other scaling factors or gains to control the high-pressure pump to reduce rail pressure deviation (the difference between desired rail pressure 510 and measured rail pressure 520) as represented by block 550. Control of the high-pressure pump is preferably performed using a proportional metering valve as represented by block 552.

As described above, the present invention provides various systems and methods for more accurately controlling pressure in a common rail fluid distribution system having variable gains. The invention may be used to improve performance and emissions for common rail systems and may lead to improved driveability in vehicle applications. Some embodiments may reduce necessary calibration effort and controller memory requirements while also improving control accuracy relative to prior art approaches.

What is claimed is:

1. A method for controlling pressure within a common rail fluid distribution system for distributing a pressurized fluid from a pump to at least two locations of a multi-cylinder internal combustion engine, the method comprising:
determining engine speed;
determining a desired rail pressure;
determining a measured rail pressure;
determining a rail pressure deviation based on the desired and measured rail pressures;
determining at least one control parameter based on the engine speed and a quantity of the fluid; and
controlling pressure of the fluid from the pump to reduce the rail pressure deviation based on the at least one control parameter.

2. The method of claim 1 wherein the at least one control parameter includes a proportional gain, an integral gain, and a derivative gain for a feedback controller.

3. The method of claim 1 wherein the fluid comprises hydraulic fluid.

4. The method of claim 1 wherein the fluid comprises fuel and wherein the quantity of the fluid comprises a quantity of fuel injected per engine cycle.

5. The method of claim 4 wherein each engine cycle includes two engine revolutions.

6. The method of claim 1 wherein the fluid comprises fuel and wherein the quantity of the fluid comprises a quantity of fuel pumped per engine cycle.

7. The method of claim 6 wherein each engine cycle includes two engine revolutions.

8. The method of claim 1 wherein the fluid comprises fuel and wherein the quantity of the fluid comprises a quantity of fuel pumped per unit time.

9. The method of claim 1 wherein the control parameter comprises a feed forward open loop setpoint.

10. The method of claim 9 wherein the fluid comprises fuel and wherein the quantity of the fluid comprises a quantity of fuel pumped per engine cycle.

11. The method of claim 9 wherein each engine cycle includes two engine revolutions.

12. The method of claim 9 wherein the fluid comprises fuel and wherein the quantity of the fluid comprises a quantity of fuel pumped per unit time.

13. A computer readable storage medium having stored data representing instructions executable by a computer to control pressure within a common rail fluid distribution system for distributing a pressurized fluid from a pump to at least two locations of a multi-cylinder internal combustion engine, the computer readable storage medium comprising:
instructions for determining engine speed;
instructions for determining a rail pressure deviation based on desired and measured rail pressures;
instructions for determining at least one control parameter based on the engine speed and a quantity of the fluid; and
instructions for controlling the pump to reduce the rail pressure deviation based on the at least one control parameter.

14. The computer readable storage medium of claim 13 wherein the at least one control parameter includes a proportional gain, an integral gain, and a derivative gain for a feedback controller.

15. The computer readable storage medium of claim 13 wherein the fluid comprises fuel and wherein the quantity of the fluid comprises a quantity of fuel injected per engine cycle.

16. The computer readable storage medium of claim 13 wherein the fluid comprises fuel and wherein the quantity of the fluid comprises a quantity of fuel pumped per engine cycle.

17. The computer readable storage medium of claim 13 wherein the fluid comprises fuel and wherein the quantity of the fluid comprises a quantity of fuel pumped per unit time.

18. The computer readable storage medium of claim 13 wherein the at least one control parameter comprises a feed forward open loop setpoint.

19. The computer readable storage medium of claim 18 wherein the fluid comprises fuel and wherein the quantity of the fluid comprises a quantity of fuel pumped per engine cycle.

20. The computer readable storage medium of claim 18 wherein the fluid comprises fuel and wherein the quantity of the fluid comprises a quantity of fuel pumped per unit time.

21. A system for controlling pressure within a common rail fluid distribution system of a multi-cylinder internal combustion engine having a fuel injector associated with each cylinder and coupled to a common fluid distribution rail, the system comprising:
a pump coupled to the common fluid distribution rail;
a pressure sensor coupled to the common fluid distribution rail for providing a signal indicative of pressure within the rail;
an engine speed sensor for providing a signal indicative of engine speed; and
a controller in communication with the engine speed sensor, the pressure sensor, the pump, and the injectors, the controller determining a deviation between a desired rail pressure and a measured rail pressure and determining at least one control parameter based on the engine speed and a quantity of the fluid to generate a control signal for the pump to reduce the rail pressure deviation based on the at least one control parameter.

22. The system of claim 21 wherein the control parameter comprises a proportional gain, an integral gain, and a derivative gain for a feedback controller.

23. The system of claim 21 wherein the fluid comprises hydraulic fluid used to actuate the injectors.

24. The system of claim 21 wherein the fluid comprises fuel and wherein the quantity of the fluid comprises a quantity of fuel injected per engine cycle.

25. The system of claim 21 wherein the fluid comprises fuel and wherein the quantity of the fluid comprises a quantity of fuel pumped per engine cycle.

26. The system of claim 21 wherein the fluid comprises fuel and wherein the quantity of the fluid comprises a quantity of fuel pumped per unit time.

27. The system of claim 21 wherein the at least one control parameter comprises a feed forward open loop setpoint.

28. The system of claim 27 wherein the fluid comprises fuel and wherein the quantity of the fluid comprises a quantity of fuel pumped per engine cycle.

29. The system of claim 27 wherein the fluid comprises fuel and wherein the quantity of the fluid comprises a quantity of fuel pumped per unit time.

30. The system of claim 21 wherein the control parameter comprises a plurality of proportional gains, integral gains, and derivative gains stored in a memory in communication with the controller with a current value for each gain retrieved based on the engine speed and the quantity of fluid.
